(19) United States
(12) Patent Application Publication
(10) Pub. No.: US 2014/0136620 A1
(43) Pub. Date: May 15, 2014

(54) PROTOCOL CONVERSION APPARATUS AND METHOD

(71) Applicant: Electronics and Telecommunications Research Institute, Daejeon (KR)

(72) Inventors: Seung Chul SON, Gwangju (KR); Il Kyun PARK, Gwangju (KR); Byung-Tak LEE, Gyeonggi-do (KR); Young Sun KIM, Daejeon (KR)

(73) Assignee: Electronics and Telecommunications Research Institute, Daejeon (KR)

(21) Appl. No.: 14/041,915

(22) Filed: Sep. 30, 2013

(30) Foreign Application Priority Data
Nov. 12, 2012 (KR) 10-2012-0127742

(51) Int. Cl. H04L 29/06

(52) U.S. Cl. CPC H04L 67/42
USPC 709/204

(57) ABSTRACT

A protocol conversion apparatus includes: a message filter unit for acquiring a unique type identifier by comparing an input message based on a first protocol to a message mask stored in a mask storage unit, and acquiring a message parameter by filtering the input message through the message mask; and a message generation unit for extracting a message template corresponding to the unique type identifier from a template storage unit, and generating an output message based on a second protocol by synthesizing the message parameter and the message template.

### CROSS-REFERENCES TO RELATED APPLICATIONS

The present application claims priority under 35 U.S.C 119(a) to Korean Application No. 10-2012-0127742, filed on Nov. 12, 2012, in the Korean intellectual property Office, which is incorporated herein by reference in its entirety set forth in full.

### BACKGROUND

Exemplary embodiments of the present invention relate to a protocol conversion apparatus and method, and more particularly, to a protocol conversion apparatus and method which acquires effective data from a message inputted as a specific protocol using a message mask and a unique type identifier which are previously stored, reflecting the acquired data into a message template, and converting the input message into a target protocol of message.

In general, a protocol indicates a promise for various communication rules and methods which are determined to smoothly exchange messages between information devices, that is, a set of communication rules.

Therefore, in order for information devices using different protocols to communicate with each other, a protocol conversion process is required.

Conventionally, a fixed mapping table between previously-stored protocols has been used to convert a protocol.

That is, the detailed information of a protocol inputted to a protocol conversion apparatus and the detailed information of a target protocol are previously specified by an administrator. Furthermore, the protocol conversion apparatus recognizes the protocol specification by receiving node information from a node which inputs a message.

According to this method, however, a protocol message is limited per sensor, or a modification of the protocol conversion apparatus is required. Furthermore, in order to input a new protocol, the protocol conversion apparatus must be modified according to the detailed information of the protocol.

In the communication industry, each maker has a large number of legacy protocols, and a variety of target systems collecting the messages exist. Therefore, there is a limitation in applying the conventional protocol conversion apparatus to the variety of target systems.

As the related art, Korean Patent No. 1,148,475 discloses a protocol conversion pre-processing method and apparatus and a protocol conversion apparatus.

### SUMMARY

An embodiment of the present invention relates to a protocol conversion apparatus and method which is capable of easily converting a message inputted as a specific protocol into a target protocol of message and may be quickly applied to a target system.

In one embodiment, a protocol conversion apparatus includes: a message filter unit for acquiring a unique type identifier by comparing an input message based on a first protocol to a message mask stored in a mask storage unit, and acquiring a message parameter by filtering the input message through the message mask; and a message generation unit for extracting a message template corresponding to the unique type identifier from a template storage unit, and generating an output message based on a second protocol by synthesizing the message parameter and the message template.

The input message may be inputted from a first device, and the output message may be outputted to a second device.

The first and second devices may have a server-client relationship.

In another embodiment, a protocol conversion apparatus includes: a downward message filter unit for acquiring a first unique type identifier by comparing a first-protocol-based first input message received from a server to a first message mask stored in a mask storage unit, and acquiring a first message parameter by filtering the first input message through the first message mask; a downward message generation unit for extracting a first message template corresponding to the first unique type identifier from a template storage unit, generating a second-protocol-based first output message by synthesizing the first message parameter and the first message template, and providing the generated first output message to a client; an upward message filter unit for acquiring a second unique type identifier by comparing a second-protocol-based second input message received from the client to a second message mask stored in the mask storage unit, and acquiring a second message parameter by filtering the second input message through the second message mask; and an upward message generation unit for extracting a second message template corresponding to the second unique type identifier from the template storage unit, generating a first-protocol-based second output message by synthesizing the second message parameter and the second message template, and providing the generated second output message to the server.

In another embodiment, a protocol conversion method includes: comparing, by a message filter unit, an input message based on a first protocol to a message mask stored in a mask storage unit, and acquiring a unique type identifier for the input message; filtering, by the message filter unit, the input message through the message mask and acquiring a message parameter; extracting, by a message generation unit, a message template corresponding to the unique type identifier from a template storage unit; and synthesizing, by the message generation unit, the message parameter and the message template and generating an output message based on a second protocol.

The input message may be inputted from a first device, and the output message may be outputted to a second device.

The first and second devices may have a server-client relationship.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram illustrating the configuration of a protocol conversion apparatus in accordance with an embodiment of the present invention;

FIG. 2 is a flow chart showing a protocol conversion method in accordance with the embodiment of the present invention;

FIG. 3 is a block diagram illustrating the configuration of a server-client system including the protocol conversion apparatus in accordance with the embodiment of the present invention;

FIG. 4 is a block diagram illustrating the detailed configuration of the protocol conversion apparatus included in the server-client system;

FIG. 5 is a diagram illustrating the process in which the protocol conversion apparatus included in the server-client system of FIG. 3 down-converts the protocol of a message inputted from a server and outputs a message to a client; and

FIG. 6 is a diagram illustrating the process in which the protocol conversion apparatus included in the server-client system of FIG. 3 up-converts the protocol of a message inputted from the client and outputs a message to the server.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention. The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms are based on the overall descriptions of the present specification.

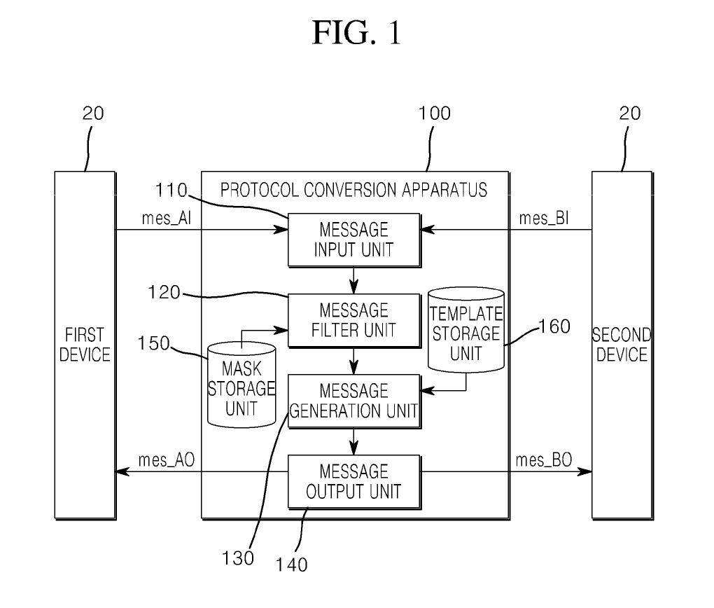

FIG. 1 is a block diagram illustrating the configuration of a protocol conversion apparatus in accordance with an embodiment of the present invention.

Referring to FIG. 1, the protocol conversion apparatus 100 in accordance with the embodiment of the present invention converts a protocol between first and second devices 20 and 30. The first device 20 is configured to perform communication through an A protocol, and the second device 30 is configured to perform communication through a B protocol.

That is, the protocol conversion apparatus 100 in accordance with the embodiment of the present invention converts an A protocol-based input message Mes_AI received from the first device 20 into a B protocol-based output message Mes_BO usable in the second device 30, and provides the output message Mes_BO to the second device 30.

Furthermore, the protocol conversion apparatus 100 in accordance with the embodiment of the present invention converts a B protocol-based input message Mes_BI received from the second device 30 into an A protocol-based output message Mes_AO usable in the first device 20, and provides the output message Mes_AO to the first device 20.

Referring to FIG. 1, the protocol conversion apparatus 100 in accordance with the embodiment of the present invention includes a message input unit 110, a message filter unit 120, a message generation unit 130, a message output unit 140, a mask storage unit 150, and a template storage unit 160.

The message input unit 110 is configured to transmit the A protocol-based input message Mes_AI received from the first device 20 or the B protocol-based input message Mes_BI received from the second device 30 to the message filter unit 120.

The message filter unit 120 is configured to compare the input message Mes_AI or Mes_BI transmitted from the message input unit 110 to a message mask stored in the mask storage unit 150, and acquire a unique type identifier.

Furthermore, the message filter unit 120 filters the input message Mes_AI or Mes_BI through the message mask corresponding to the acquired unique type identifier, and acquires an effective message parameter.

The message filter unit 120 outputs the acquired unique type identifier and the acquired message parameter to the message generation unit 130.

The message generation unit 130 is configured to extract a message template, which corresponds to the unique type identifier inputted from the message filter unit 120, from the template storage unit 160.

Furthermore, the message generation unit 130 synthesizes the extracted message template and the message parameter inputted from the message filter unit 120, and generates the B protocol-based output message Mes_BO or the A protocol-based output message Mes_AO.

The message output unit 140 is configured to provide the B protocol-based output message Mes_BO generated by the message generation unit 130 to the second device 30, and provide the A protocol-based output message Mes_AO to the first device 30.

The mask storage unit 150 is configured to store unique type identifiers corresponding to message masks, and the template storage unit 160 is configured to store message templates.

The message masks, the unique type identifiers, and the message templates may be stored in a database form by preliminary analysis on various protocol messages.

Meanwhile, the first and second devices 20 and 30 include various terminals such as computer, notebook computer, netbook computer, smart phone, mobile phone, tablet PC, and PDA, which are capable of perform data communication.

The first and second devices 20 and 30 may have a server-client relationship.

A protocol conversion process when the first device 20 is configured as a server 21 and the second device 30 is configured as a client 31 will be described below with reference to FIGS. 3 to 6.

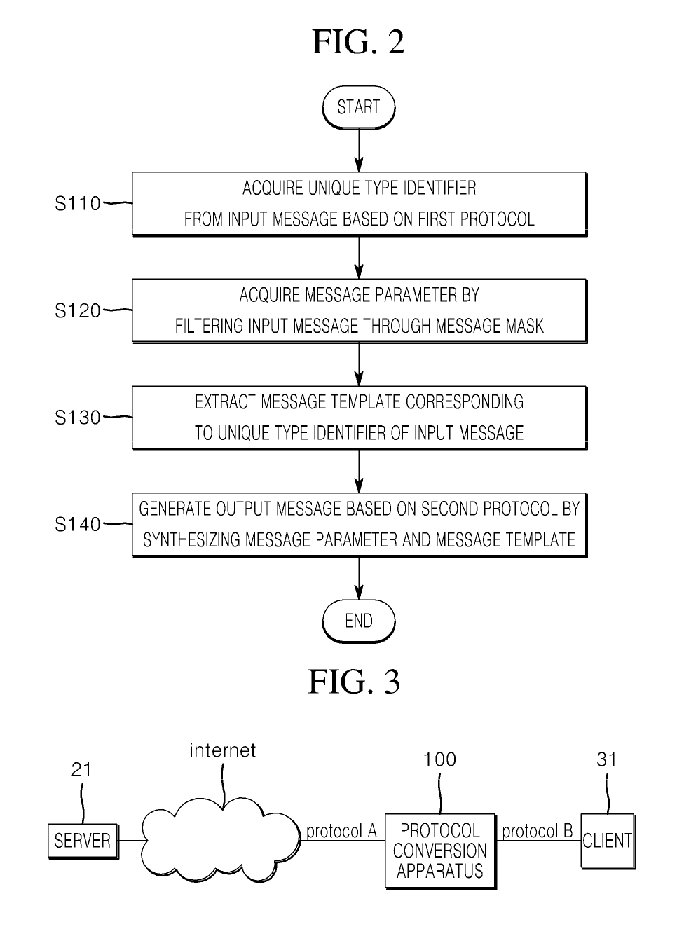

FIG. 2 is a flow chart showing a protocol conversion method in accordance with the embodiment of the present invention.

Referring to FIG. 2, the message filter unit 120 of the protocol conversion apparatus 100 acquires a unique type identifier from an input message which is based on a first protocol (for example, the A protocol) and received from the first device 20, at step S110.

At this time, the message filter unit 120 may acquire the unique type identifier by comparing the input message to a message mask stored in the mask storage unit 150.

Then, the message filter unit 120 filters the input message through the message mask stored in the mask storage unit 150 and extracts an effective message parameter at step S120.

Subsequently, the message generation unit 130 of the protocol conversion apparatus 100 extracts a message template, which corresponds to the unique type identifier acquired by the message filter unit 120, from the template storage unit 160 at step S130.

Then, the message generation unit 130 synthesizes the message parameter extracted by the message filter unit 120 and the extracted message template, generates an output message based on a second protocol (for example, the B protocol), and provides the generated output message to the second device 30, at step S140.

In this embodiment of the present invention, it has been described that the protocol of the input message received from the first device 20 is converted and provided to the second device 30. However, this embodiment of the present invention may also be applied to a case in which the protocol of an input message received from the second device 30 is converted and provided to the first device 20.

As such, the message mask and the unique type identifier which are previously stored may be used to extract effective data from the input message, and the extracted data and the message template may be synthesized to easily convert the input message into a target protocol of message.

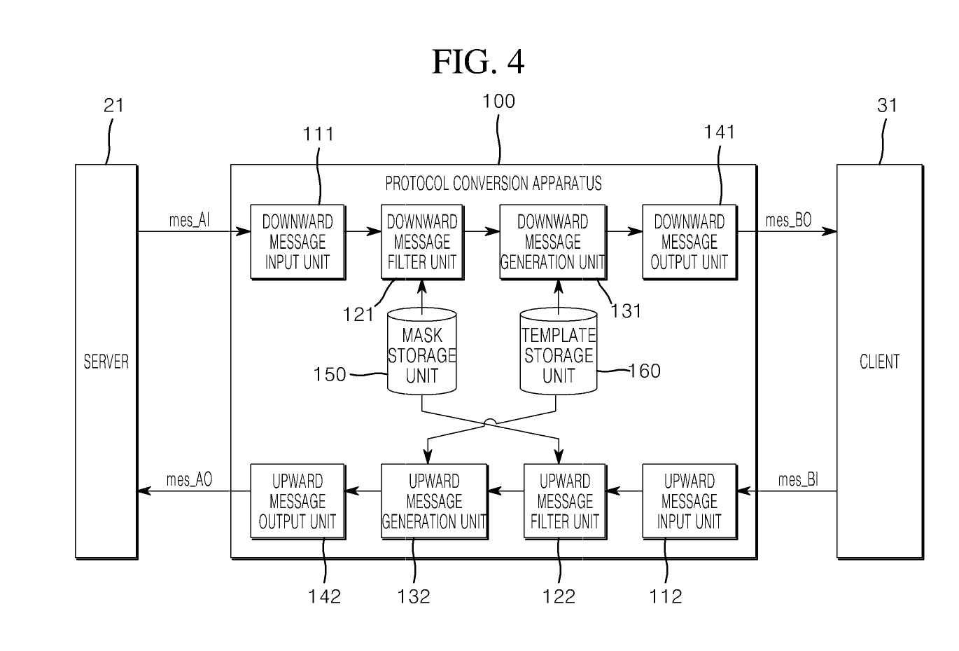

FIG. 3 is a block diagram illustrating the configuration of a server-client system including the protocol conversion apparatus in accordance with the embodiment of the present invention. FIG. 4 is a block diagram illustrating the detailed configuration of the protocol conversion apparatus included in the server-client system.

Referring to FIG. 3, the protocol conversion apparatus 100 in accordance with the embodiment of the present invention may be configured to perform a protocol conversion operation between a server 21 and a client 31. The server 21 is configured to perform communication through the A protocol, and the client 31 is configured to perform communication through the B protocol.

Referring to FIG. 4, the protocol conversion apparatus 100 in accordance with the embodiment of the present invention includes a downward message input unit 111, an upward message input unit 112, a downward message filter unit 121, an upward message filter unit 122, a downward message generation unit 131, an upward message generation unit 132, a downward message output unit 141, an upward message output unit 142, a mask storage unit 150, and a template storage unit 160.

The downward message input unit 111, the downward message filter unit 121, the downward message generation unit 131, and the downward message output unit 141 down-convert an input message mes_AI received from the server 21 and generate an output message mes_BO to provide to the client 31.

On the other hand, the upward message input unit 112, the upward message filter unit 122, the upward message generation unit 132, and the upward message output unit 142 up-convert an input message mes_BI received from the client 31 and generate an output message mes_AO to provide to the server 21.

That is, a path through which a message is transmitted from the server 21 to the client 31 and a path through which a message is transmitted from the client 31 to the server 21 may be formed separately from each other.

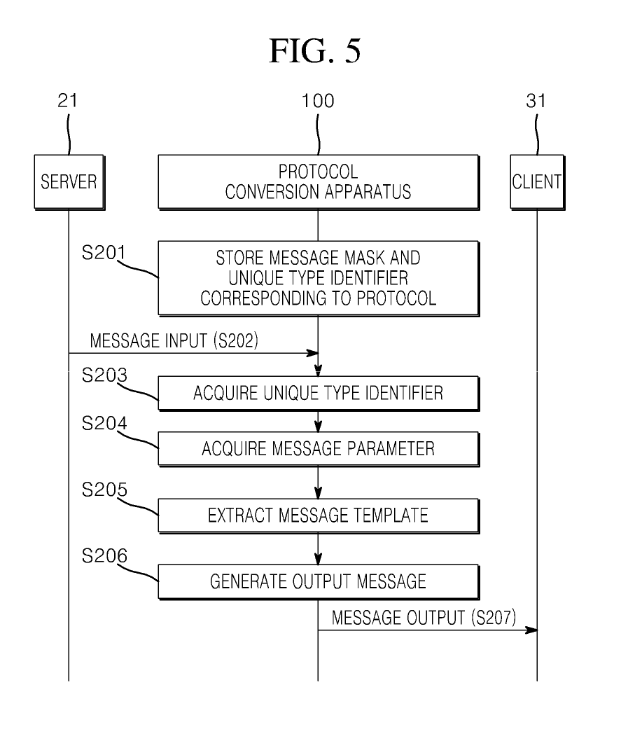

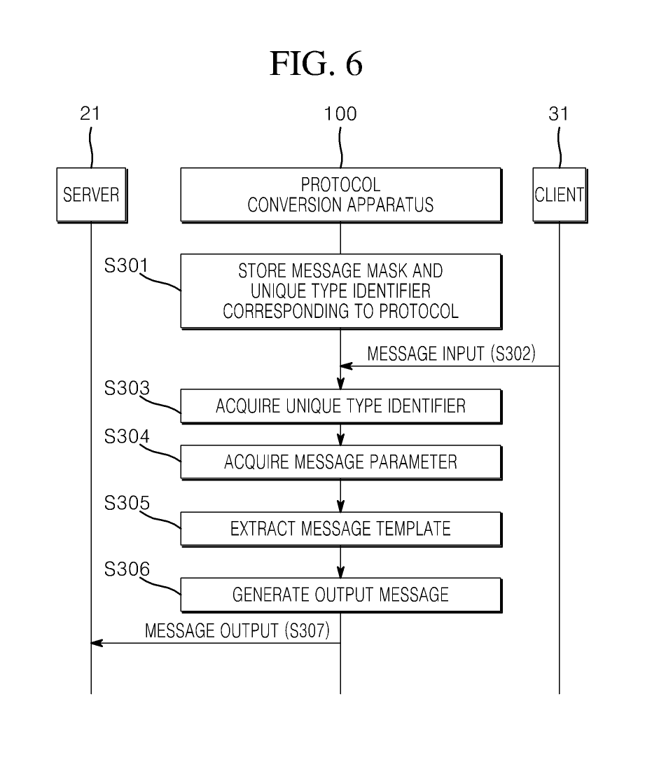

Since the operations of the respective components for protocol conversion correspond to those described with reference to FIG. 1, the detailed descriptions thereof are omitted herein. Referring to FIGS. 5 and 6, the down-conversion operation and the up-conversion operation of the protocol will be described.

FIG. 5 is a diagram illustrating the process in which the protocol conversion apparatus included in the server-client system of FIG. 3 down-converts the protocol of a message inputted from the server and outputs a message to the client.

Referring to FIG. 5, the mask storage unit 150 of the protocol conversion apparatus 100 stores a message mask and a unique type identifier corresponding to the message mask, and the template storage unit 160 stores a message template, at step S201.

The message mask, the unique type identifier, and the message template may be stored in a database form by preliminary analysis on various protocol messages.

Then, when an A protocol-based input message is received from the server 21 at step S202, the downward message filter unit 121 of the protocol conversion apparatus 100 compares the input message to a message mask stored in the mask storage unit 150 and acquires a unique type identifier, at step S203.

Furthermore, the downward message filter unit 121 filters the input message through the message mask stored in the mask storage unit 150 and extracts an effective message parameter, at step S204.

Then, the downward message generation unit 131 of the protocol conversion apparatus 100 extracts a message template, which corresponds to the unique type identifier acquired by the downward message filter unit 121, from the template storage unit 160 at step S205.

Subsequently, the downward message generation unit 131 generates a B protocol-based output message by synthesizing the message parameter extracted by the downward message filter unit 121 and the extracted message template at step S206, and provides the generated output message to the client 31 at step S207.

FIG. 6 is a diagram illustrating the process in which the protocol conversion apparatus included in the server-client system of FIG. 3 up-converts the protocol of a message inputted from the client and outputs a message to the server.

Referring to FIG. 6, the mask storage unit 150 of the protocol conversion apparatus 100 stores a mask message and a unique type identifier corresponding to the message mask and the template storage unit 160 stores a message template, at step S301.

The message mask, the unique type identifier, and the message template may be stored in a database form by preliminary analysis on various protocol messages.

Then, when a B protocol-based input message is received from the client 31 at step S302, the upward message filter unit 122 of the protocol conversion apparatus 100 compares the input message to the message mask stored in the mask storage unit 150 and acquires a unique type identifier, at step S303.

Furthermore, the upward message filter unit 122 filters the input message through the message mask stored in the mask storage unit 150 and extracts an effective message parameter, at step S304.

Then, the upward message generation unit 132 of the protocol conversion apparatus 100 extracts a message template, which corresponds to the unique type identifier acquired by the upward message filter unit 122, from the template storage unit 160 at step S305.

Subsequently, the upward message generation unit 132 generates an A protocol-based output message by synthesizing the message parameter extracted by the upward message filter unit 131 and the message template at step S306, and provides the generated output message to the server 21 at step S307.

The protocol conversion apparatus and method in accordance with the embodiments of the present invention may extract effective data from an input message using the message mask and the unique type identifier which are previously stored, and easily convert the input message into a target protocol of message by synthesizing the effective data and the message template.

Furthermore, since the protocol conversion apparatus and method may be widely applied to legacy message protocols acquired from existing apparatuses, the protocol conversion apparatus and method may be quickly applied to a target system.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A protocol conversion apparatus comprising:
a message filter unit for acquiring a unique type identifier by comparing an input message based on a first protocol to a message mask stored in a mask storage unit, and acquiring a message parameter by filtering the input message through the message mask; and
a message generation unit for extracting a message template corresponding to the unique type identifier from a template storage unit, and generating an output message based on a second protocol by synthesizing the message parameter and the message template.

2. The protocol conversion apparatus of claim 1, wherein the input message is inputted from a first device, and the output message is outputted to a second device.

3. The protocol conversion apparatus of claim 2, wherein the first and second devices have a server-client relationship.

4. A protocol conversion apparatus comprising:
a downward message filter unit for acquiring a first unique type identifier by comparing a first-protocol-based first input message received from a server to a first message mask stored in a mask storage unit, and acquiring a first message parameter by filtering the first input message through the first message mask;
a downward message generation unit for extracting a first message template corresponding to the first unique type identifier from a template storage unit, generating a second-protocol-based first output message by synthesizing the first message parameter and the first message template, and providing the generated first output message to a client;
an upward message filter unit for acquiring a second unique type identifier by comparing a second-protocol-based second input message received from the client to a second message mask stored in the mask storage unit, and acquiring a second message parameter by filtering the second input message through the second message mask; and
an upward message generation unit for extracting a second message template corresponding to the second unique type identifier from the template storage unit, generating a first-protocol-based second output message by synthesizing the second message parameter and the second message template, and providing the generated second output message to the server.

5. A protocol conversion method comprising:
comparing, by a message filter unit, an input message based on a first protocol to a message mask stored in a mask storage unit, and acquiring a unique type identifier for the input message;
filtering, by the message filter unit, the input message through the message mask and acquiring a message parameter;
extracting, by a message generation unit, a message template corresponding to the unique type identifier from a template storage unit; and
synthesizing, by the message generation unit, the message parameter and the message template and generating an output message based on a second protocol.

6. The protocol conversion method of claim 5, wherein the input message is inputted from a first device, and the output message is outputted to a second device.

7. The protocol conversion method of claim 6, wherein the first and second devices have a server-client relationship.
